(19) United States
(12) Patent Application Publication
(10) Pub. No.: US 2012/0128330 A1
(43) Pub. Date: May 24, 2012

(54) SYSTEM AND METHOD FOR VIDEO RECORDING DEVICE DETECTION

(75) Inventors: Mehdi Mahdavi, Ottawa (CA); Hesam Mahdavi, Ottawa (CA); Fred Farsi, Ottawa (CA)

(73) Assignee: PIKAIA SYSTEMS INC., Ottawa (CA)

(21) Appl. No.: 12/950,523

(22) Filed: Nov. 19, 2010

(51) Int. Cl. H04N 9/80

(52) U.S. Cl. 386/252; 386/E05.003

(57) ABSTRACT

A system, apparatus and method for detection of recording device in a theater environment are provided. The seating area is illuminated with an infrared lighting source. Surface reflections generated by a lens of a recording device is received by an image capture device. An image from the image capture device is analyzed for identifying patterns associated with reflections from a lens. A seating position associated with the reflection is then identified.

### TECHNICAL FIELD

The present disclosure relates to video recording copyright piracy and in particular detecting illegal video recording devices in a theater environment.

### BACKGROUND

The ever increasing improvements in portable video recording devices in terms of size and picture quality has resulted in an increase in piracy and illegal copies copyrighted performances, particularly movies. Piracy is a significant problem in motion picture industry having significant financial impact in terms of lost potential revenue. Recording devices such as camcorder; mini-digital video records, and mobile phones can be easily concealed in large or dark theaters. A recorded performance can then easily be distributed by the Internet or through DVD copies resulting in lost revenue. A pirated recording of a first run movie can result in the loss of significant revenue. Watermarking technologies have limited success as the pirated movie must be traced back to an originating location or theater and with more difficult to the person who made the recording to be an effective deterrent. Active piracy systems have limited success and can potentially be defeated. In order to actively stop piracy of movie piracy the person doing the recording must be identified in the process of recording and appropriate action taken.

Current detection technologies rely on an optical phenomenon called retro-reflection. Retro-reflection occurs when a reflective or partially reflective objects is placed in the focal plane of a lens. Any light then illuminated to lens will be reflected back on itself towards the light source. To be able to get this kind of reflection back from a lens the light source and detection system have to be in front of the lens and inside its field of view (FOV) which in an environment like a theater imposes serious limitations for detecting all cameras in all seats. More over a complex set of lenses (called objective lens) in a high quality camera makes it almost impossible to get a retro reflection from camera when camera is focused on the screen, unless detection system remains in field of view which can obstruct the screen. The main disadvantages of retro reflection technique is that they have to use visible light sources. Camcorder companies cover the front lens of camera with antireflection coating layers. The antireflection coating is designed to pass the visible light and to reflect the IR light back. Some cameras have night vision capability which allows 800 nm wavelength to go through the lens. The front surface coating of a camcorder then reflects back all IR lights over 850 nm. A retro reflector detecting system then has to transmit the light into optical system and get the reflection from focal point back. A visible light source that is in the range of maximum transmission wavelength must be used to detect the lens system. Using visible light sources or IR sources up to 850 nm will also cause distraction since even at 850 nm wavelength the light sources are visible to audience.

Therefore there is a need for system, method and apparatus for video recording device detection that provides real-time detection and identification of a user that is invisible to audience and also does not block the screen.

### BRIEF DESCRIPTION OF THE DRAWINGS

Further features and advantages of the present disclosure will become apparent from the following detailed description, taken in combination with the appended drawings, in which:

FIG. 1 is an illustration of a theater environment;

FIG. 2 is a representation of surface reflection for pattern detection;

FIG. 3 is an illustration of behind the screen illumination;

FIG. 4 is an illustration of behind the screen illumination with additional front illumination assistance;

FIG. 5 is an illustration of a system using a retro-reflector behind the screen and light source positioned close to a detection system;

FIG. 6 is an illustration of a system using a beam splitter to combine the light source and a detection system into one optical path;

FIG. 7 is an illustration of the reflection points relative to the vertical position of the recording device;

FIG. 8 is an diagram of the reflection angles;

FIG. 9 is an illustration of the reflection points using a laser scanner illumination source;

FIG. 10 is a representation of an optical surface reflection pattern generated by a circular illumination array;

FIG. 11 is a representation of an optical surface reflection pattern generated by a cross illumination array;

FIG. 12 is a representation of optical surface reflection pattern at different relative location by a circular illumination array;

FIG. 13 is a representation of optical surface reflection pattern at different relative location by a linear illumination array;

FIG. 14 is a representation of optical surface reflection pattern at different relative location by a cross illumination array;

FIG. 15 is an illustration of a LED light array module configuration;

FIG. 16(a)-(d) are schematic illustrations of a LED light array apparatus;

FIG. 17 is an illustration of a LED light array positioning behind a screen;

FIG. 18 is an exemplary configuration of a pan-tilt camera with an integrated light source;

FIG. 19 is a system for detecting and alerting recording device in a theater environment;

FIG. 20 is a flow chart of recording device detection; and

FIG. 21 is a flow chart of detection system installation.

It will be noted that throughout the appended drawings, like features are identified by like reference numerals.

### SUMMARY

In accordance with an aspect of the present disclosure there is provided a system for detecting a video recording device, the system comprising: a continuous infrared illumination source for illuminating an audience seating area; an image capture device facing the audience seating area, the image capture device for capturing infrared images of the seating area; and an imaging processor coupled to the image capture device, the imaging processor receiving an image of the seating area and identifying infrared optical surface reflections within the received image, the reflections identified by a infrared reflection pattern produced by the surface of a lens of the video recording device.

In accordance with an aspect of the present disclosure there is provided A method of detecting a recording device in a theater, the method comprising: generating a continuous infrared illumination of an audience seating area in the theater; capturing an infrared image of the audience seating area; processing the image to determining if one or more infrared patterns generated by a retro-reflection from a lens surface of the recording device. The method of claim 22 wherein processing the image further comprising determining a light intensity image profile change to identify the pattern.

### DETAILED DESCRIPTION

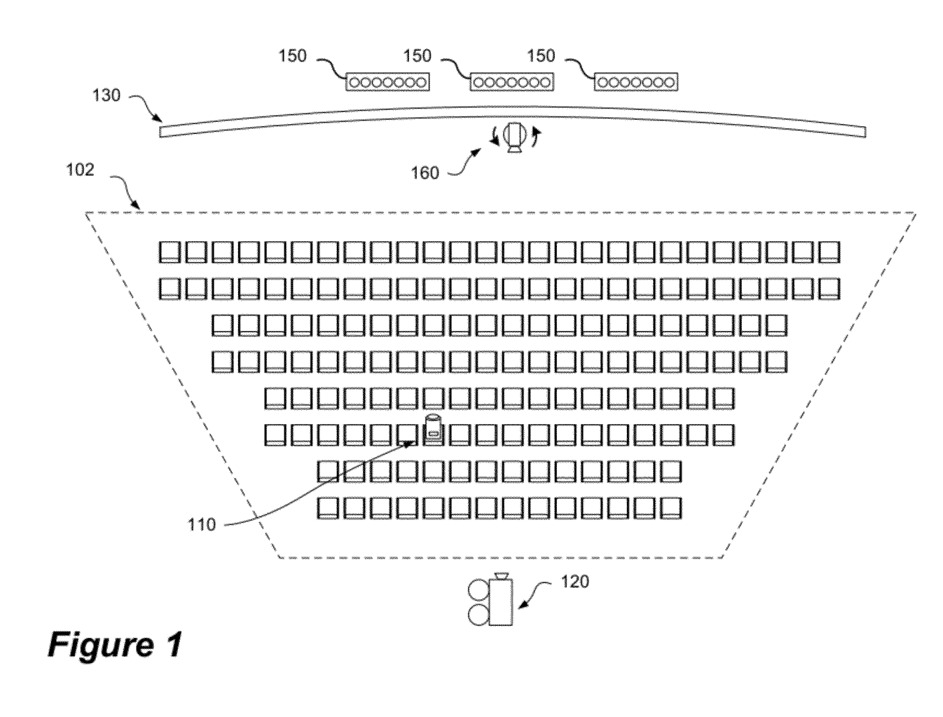

Embodiments are described below, by way of example only, with reference to FIGS. 1-21.

The following disclosure addresses video piracy and illegal video recording of the content presented in a theater environment such as for example a movie theater environment. The system, method and apparatus specifically detects the illegal video recording devices and sends an alarm to authorities. The alarm provides the coordinates of the individual who is pirating the presentation and an image file of the camcorder device as well as a real time video of the crime scene. In a theater environment, the detection of illegal recording is very difficult to capture due to various conditions and distractions that exist in the theater. The detection has to take place while the audience is watching the presentation with no noise or disturbance of any kind presented during the process. The environment is typically dark with poor lighting conditions on the audience environment.

The disclosure is based on detecting the video recording device while it is recording the movie scene illegally. A video recording device can be disguised in many ways by covering the camcorder in the clothing or hiding it in a bag or other places. However, even when it is disguised perfectly, the lens has to look straight into the movie screen this will provide an opportunity for the system to detect the video recording device. Reflections from illegal video recording device front lens are identified in a way that it is distinguishable from all other objects. An illumination system generates patterns on the surface of the illegal video recording device front lens to enable detection in processing of the captured images of an audience area. The type of the pattern depends on the arrangement of light sources behind the screen which produces a change in infrared intensity pattern defined by a intensity profile. The unique intensity profile of a reflection from an optical surface is the key parameter in detecting the optical surface. To generate the pattern on the surface of the lens, an array of infrared LED lights are utilized.

Various systems, methods and apparatus configurations are described to show different arrangements which can be used for detecting the video recording device in a theater environment. Further more an alarm system is provided to send the alarm to central monitoring stations which can respond to all the alarms generated from the various theater locations. The system is also capable of escalating the alarm signals to an alternate location if the alarm is not acknowledged within a pre specified time frame.

FIG. 1 is an illustration of a theater environment. In this example the seating area 102, or a portion of the seating area is facing a viewing screen 130. Within the seating area an illegal video recording device 110 is facing the screen 130 and recording for example a movie presentation provided by a projector 120. In order to identify the device 110 one or more infrared lights 150 illuminate the audience area. In this example illumination is provided from behind the screen 130, however illumination may be for various positions within the theater. The illumination provides uniform and bright infrared light source which is totally invisible to the human eye. Thus the presence of such a light source is not detected by audience and it will not generate any disturbance.

The infrared light(s) 150 illuminates the video recording device 110 which generates a reflection from the surface of the first lens. Reflections from the first lens of the camcorder are detected by a image capture device 160 facing the seating area. The image capture device may be positioned above, below or on either side of the presentation area or screen. The video recording device 110 will act as a partially reflecting convex mirror and will reflect back the infrared light towards image capture device 160. The reflected light then passes through a special filter on the image capture device 160 which blocks the visible light and transmits the infrared light into a CCD sensor or any other image generating sensor. The image capture device 160 can scan the audience area looking for reflections coming from illegal video recording devices 110. The captured image of the scene is then analyzed and the reflection pattern from the lens of a camcorder is recognized. An alarm can then be generated and a picture of the video recording device 110 and its location sent to the specified destination for further action.

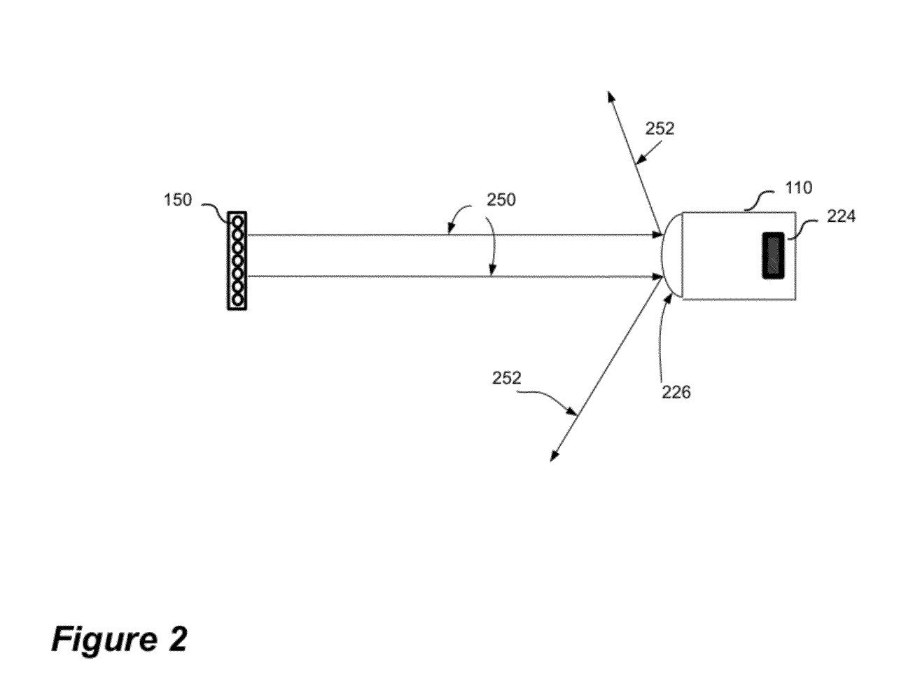

FIG. 2 is a representation of reflection from a lens surface of video recording device 110. Video recording devices are designed for best performance at visible light. Optical filters are coated on the front surface lens to protect the lens and also to reflect back the infrared light. The optical filters that are coated on the surface of the video recording devices are designed to minimise the back reflection of visible light to improve the quality. The rule of first optical surface in any recording device is to transmit maximum amount of visible light and to block infrared spectrum. Some video recording devices extend the anti reflection spectrum up to 800 nm to take shots in the night. The antireflection coating then converts into highly reflecting filter for wavelengths beyond 800 nm. As shown in FIG. 2, infrared light 250 from a light source 150 illuminates the camera lens surface 226. The light 250 is reflected 252 by the lens surface in the same way as it is reflected back from a convex mirror. Any detecting device within the reflected light area 252 can detect the reflection from surface of the lens 226.

The lens of the recording device provide surface reflections 252 of infrared light even with antireflection coating for visible light. This optical character of front surfaces of recoding devices is utilized by the present system by generating an infrared pattern that is not allowed inside the lens and optical device but is reflected back. In the presence of illumination source a recording device behaves like a mirror (lens behaves like a convex mirror and other flat objects behave like a mirror). An image capture device or scanning system 160 (including a CCD camera pan and tilt moving system, optical filters, and circular polarisers) captures or scans the audience looking for reflected patterns coming from video recording devices 110. Analysis of the images provided by a video stream, or still frames are utilized to detect an illegal recording device 110. Once a reflection is detected from a frame, the frame address or associated location is saved for second scan. After a full scan of the theater is finished then the scanner will return to saved addresses and start checking the frames for second time. Identified patterns are compared to known patterns to remove false positives. In addition frames from previous scans for the same location can be compared to determine if the pattern has moved, which likely means the object is not a video recording device of concern as ‘pirating’ device are typically stationary in order to maintain an acceptable level of picture quality.

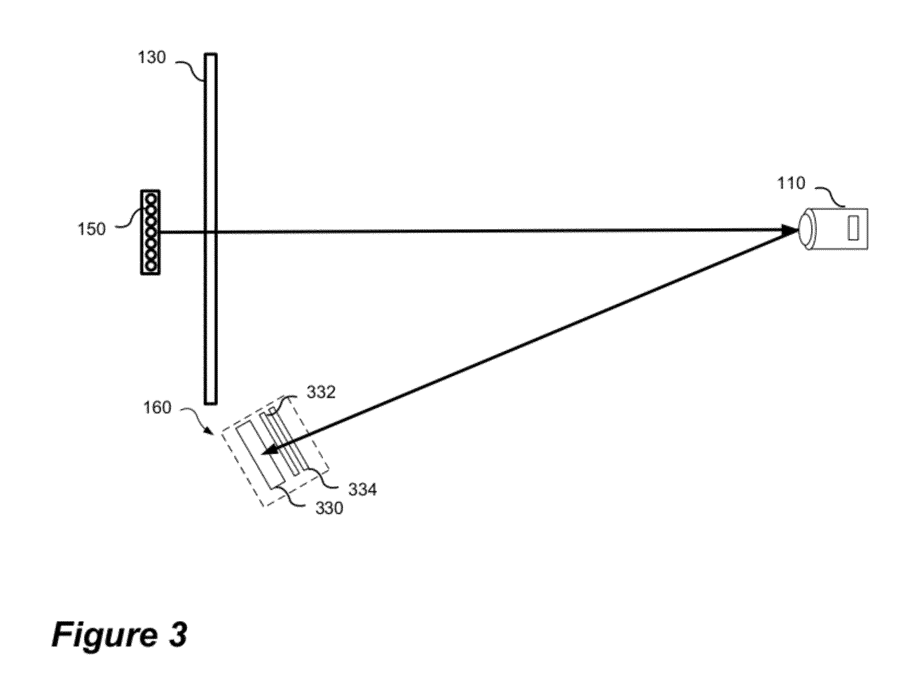

FIG. 3 is an illustration of behind the screen 130 illumination. In this example the scene is illuminated from behind the screen 130 by a wide angle illumination source 150 to generate the reflection spot by video recording device 110. The illumination sources is of sufficient size and uniformity to generate a full lens reflection of device 110. The retro-reflected light is captured by the image capture device 160 producing a reflection pattern identifiable within the image. The image capture device may comprise a charged coupled device (CCD) detection sensor 330 including additional optical and processing components not shown, with a visible light blocking filter 332 Narrow band transmission filter is designed to pass the light of illumination system only, to restrict any light other than illumination light entering the CCD, and a circular polarizer filter 334 placed in front of blocking filter 332 on the image capture device 160. The infrared reflection from the video recording device 110 passes through a circular polarized filter 334 and unwanted polarized reflections are removed from extraneous sources. The visible light is then blocked and a pure infrared image of the video recording device is detected as a high intensity pattern on the surface of the lens 110. Blocking the visible light will remove the intensity fluctuations of the scene while the presentation is displayed

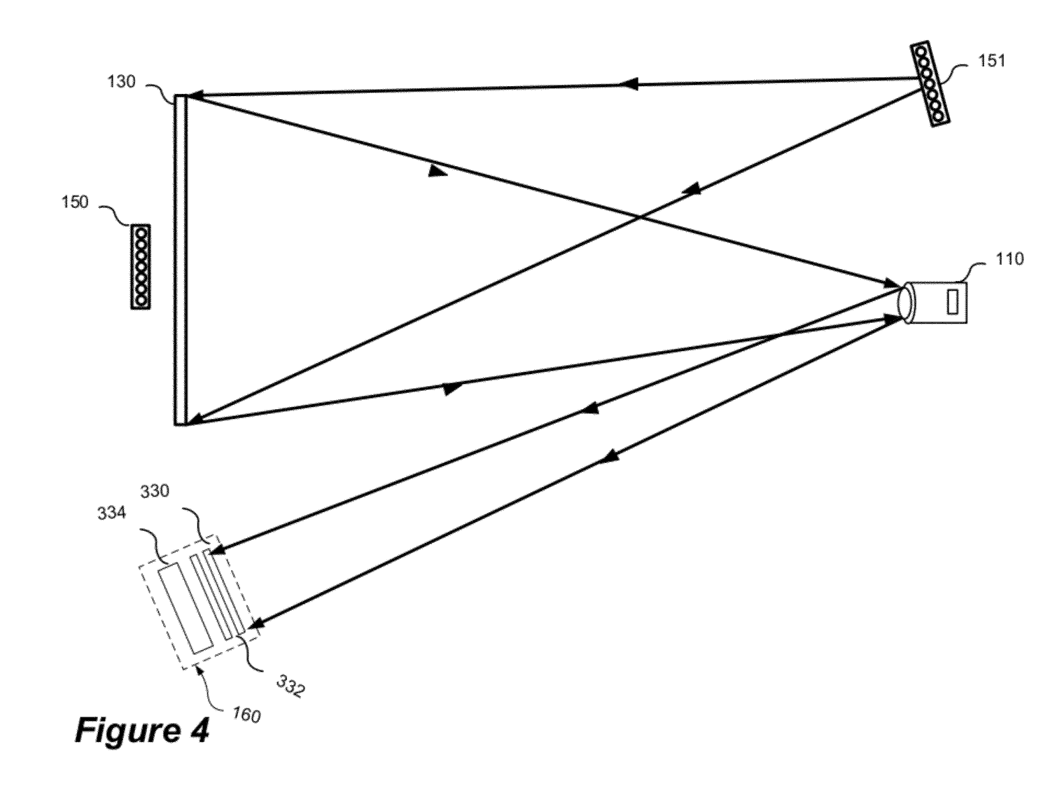

FIG. 4 is an illustration of behind the screen illumination with additional front illumination assistance. An additional wide angle infrared light illumination source 151 is provided facing toward the screen 130 to provide additional illumination to generate enough infrared reflection to record the image of the face of the subject associated with the illegal video recording device 110. Alternatively, the infrared illumination source 151 facing the screen be sufficient as a reflection back from screen 130 to illuminate the illegal video recording device 110 without the need for behind the screen illumination source 150. The illumination of the lens of the device generates a pattern on the surface of the video recording device 110. The front illumination technique enhances the detection of small lenses of pocket recording devices and also of cell phone recording devices or devices that are using a flat filter in front of the lens. The front illumination technique generate a brighter background for detection of faces of the audience and reporting of the coordinates of the image video recording device.

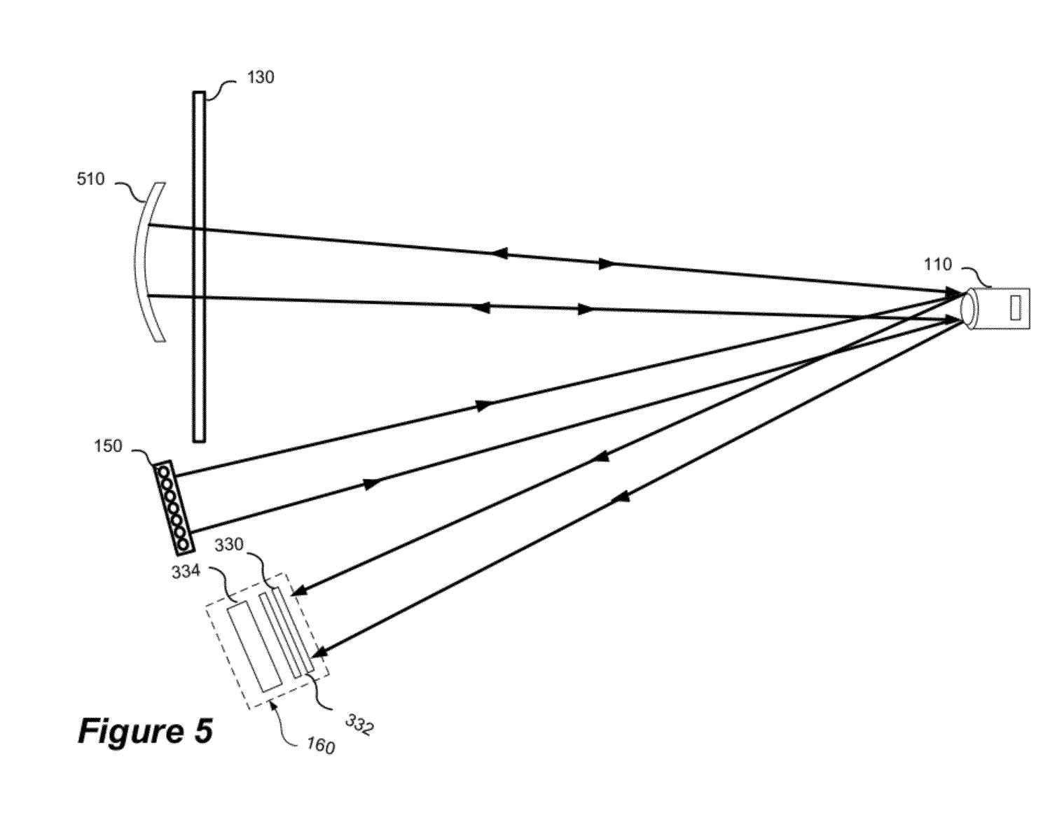

FIG. 5 is an illustration of a system using an infrared retro-reflector array 510 behind the screen and a collimated light source positioned close to a image capture device 160 (A narrow beam of light could be a light source collimated by optics to illuminate a very small spot in the audience). A collimated illumination device 150 is positioned close to image capture device 160. The illumination source 150 is an infrared light emitting source may move with the image capture device as it scans the seating area. Reflections from the lens surface of the illegal video recording device 110 reflects to the retro-reflector array 510 located behind the screen 130. The light then is reflected back on itself and travels back to the image capture device 160 to be detected.

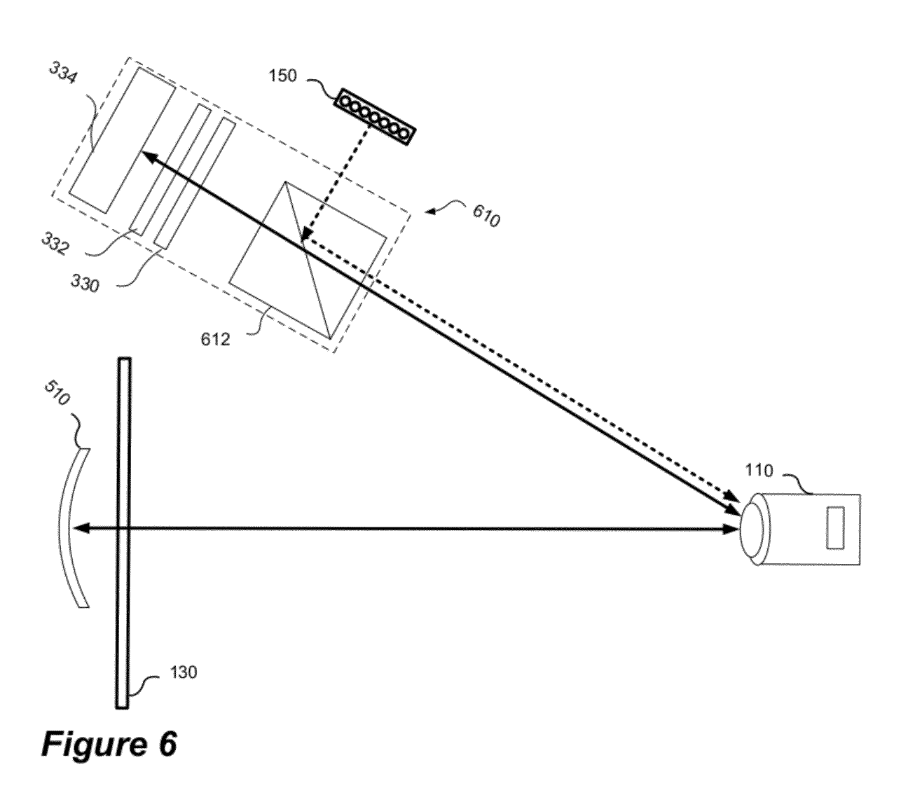

FIG. 6 is an illustration of a system using a beam splitter to combine the light source and a detection system into one optical path. In this example the image capture device 610 further comprises an infrared beam splitter prism 612 that is devised to align the light on its path to the illegal video recording device and from it. The infrared light source 150, projects a beam of light to beam splitter 612 and light is reflected to illegal video recorder device 110. This configuration allows integration of the illumination source with the image capture device 160. From illegal video recorder device 160 the same light is reflected to the screen 130 and to the retro-reflector 510 behind the screen 130. The light then reflects back on itself and will be reflected from illegal video recording device 110 to the beam splitter 612 and pass through the polarizer filter 330 and visible blocking filter 332 to the CCD camera 334. The light then scans the entire theater to generate bright reflections from the optical surfaces in the theater. The recorded video stream then is analysed to detect the illegal camcorders in the theater.

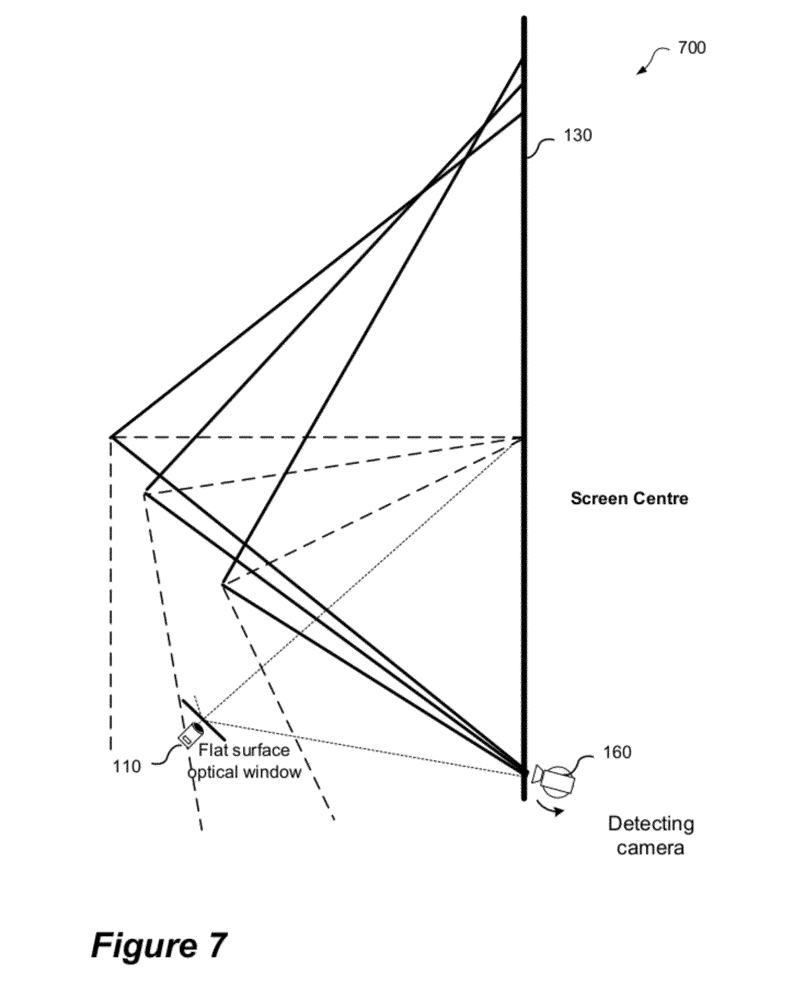

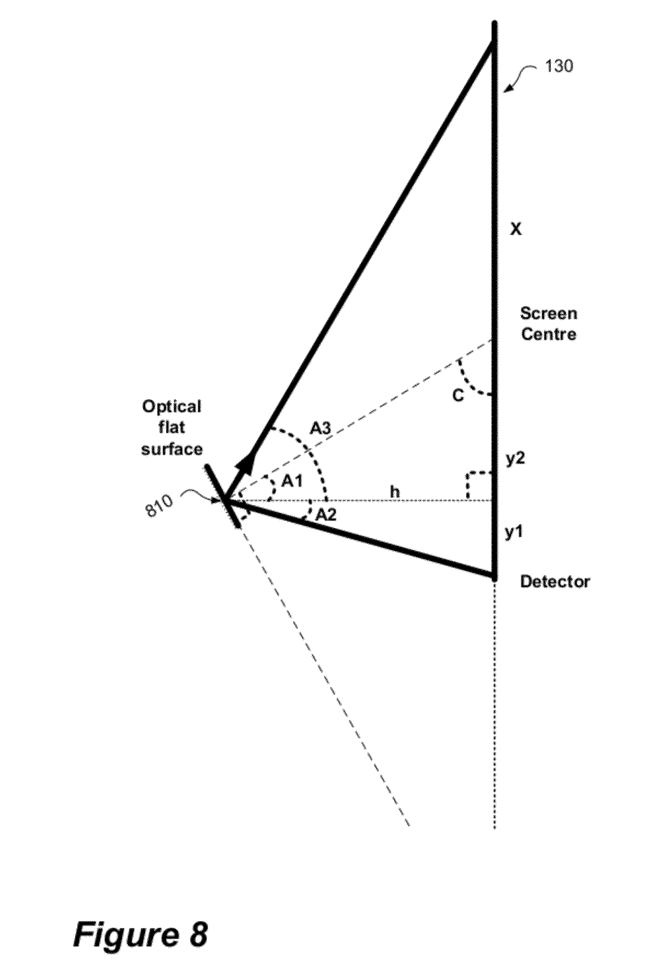

FIG. 7 is an illustration of the reflection points relative to the vertical position of the recording device using flat surface window or flat surface optical filters. In order to detect optical elements that are used in piracy for small video recording devices such as small as pocket cameras a behind screen illumination array helps detect the flat surface of the front window of pocket camcorders. In the case of piracy by small size cameras and or pocket camcorders the detection is possible by detecting a reflection from the flat surface of the front window of camera. Recording device located in the top row of the seating area reflect the lowest point from screen. As seating rows get closer to screen the reflection point of illegal video recording devices 110 moves higher. Based on following calculations provided in relation to FIG. 8, the angle of reflection is a function of distance from screen and angle of the surface of the optics 810 with respect to screen where:

A=A1+A2

A1=80−C

C=A tan (h/y2)

A2=A tan (y1/h)

h=Horizontal seat distance from screen

Y=y1+y2

y1=vertical seat height

X=The location of light source for a reflection into detector

A3=A+A1

A tan(A3)=(X+Y2)/H

X=H*(A tan (A3))−Y2

The flat surfaces reflect upper half of the theater screen toward the detection camcorder that is located on the lower part of the screen, the location of detection system can be anywhere with respect to screen as long as illumination is in the right position. Locations closer to screen will reflect higher parts of the screen.

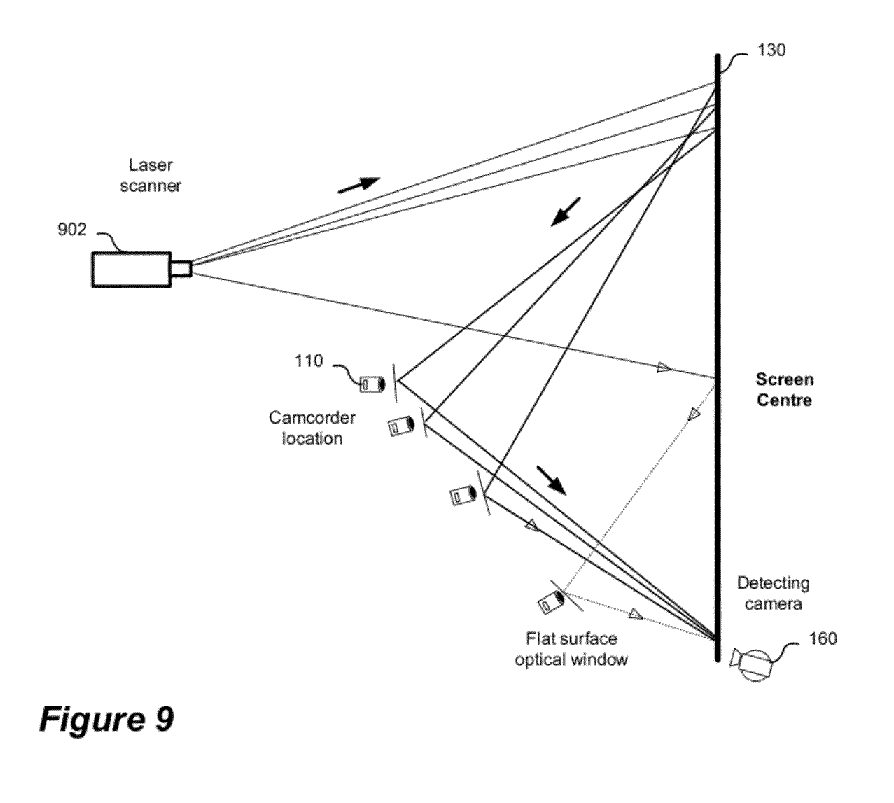

FIG. 9 is an illustration of the reflection points using an infrared laser scanner 910 illumination source. In this example laser scanner is used as the illumination source and is designed to generate very bright linear patterns on the surface of the theater screen. The top row of the seating area reflects the lowest point from screen. As rows get closer to the screen the reflection point moves higher. The laser scanner 910 can be programmed to move in synchronization with the detecting camera and cover only the part of the screen that is covered by detection system, this increasing the intensity of the light in the exact same spot that detecting camera is covering. As detecting camera is moving row by row and searching for video cameras in the theater, the scanner will start generating an intense inferred light pattern on the screen which moves with the same speed as detecting camera. The use of a laser scanner 910 can generate a unique invisible pattern that also generates a watermark (containing the cinema name). This watermark would be recorded by the illegal video recording device 110 and possibly used for later identification The filter on the device 160 is a sharp narrow pass filter designed for best transmission of the laser light.). The user of a laser scanner can be suitable for non-perforated screen or a coated screen such as an Imax™ aluminum coated screens or any model of silver screen called highly reflective screens. Providing illumination from the same angle of the main theater projector will guarantee the coverage of the entire screen and as a result a full reflection to image capture device of the video recording device 160.

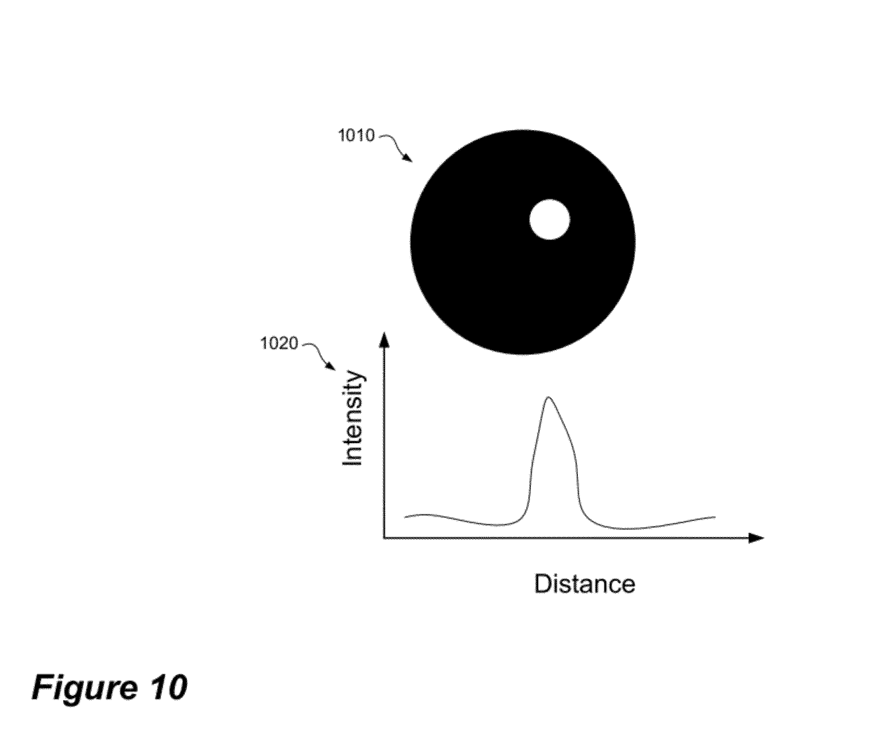

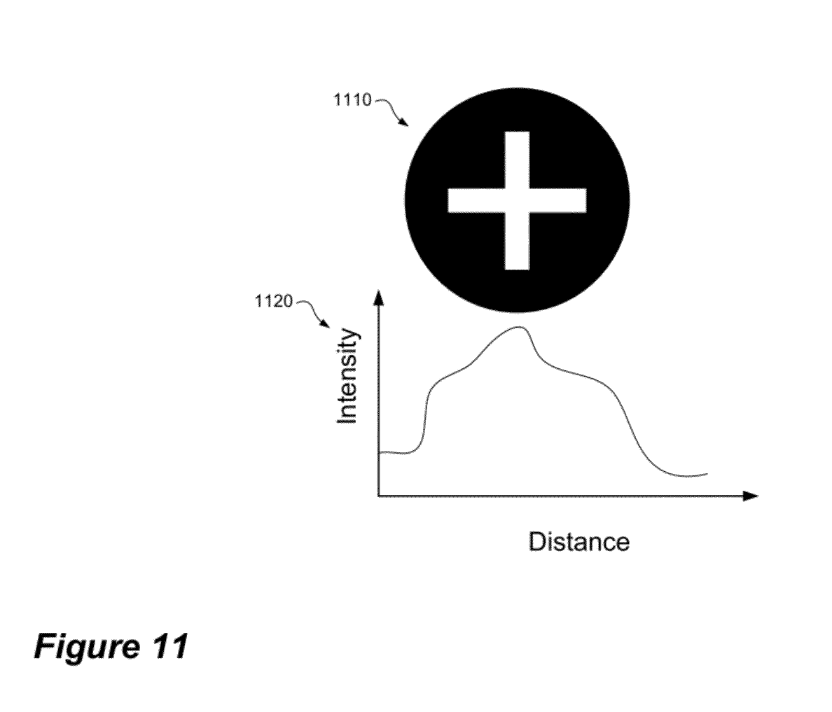

FIG. 10 is a representation of an optical surface reflection pattern 1010 generated by a circular illumination array on the front surface of the illegal video recording device using a circular light source pattern behind the screen. The bright spot is the pattern that is reflected from optical surface and will be detected by scanning device. The pattern can be in different formats and shapes generated by any device including a laser scanner or an array of light sources behind the screen. The light source and pattern generators can be in any location, they could generate the pattern on the screen or on the surface of the lens directly. The pattern can be defined graphically 1020 by comparing the brightness vs. the luminous intensity. The luminous intensity is a measure of the wavelength-weighted power emitted by a light source in a particular direction per unit solid angle, based on the luminosity function. (The sudden increase in the intensity is interpreted as a reflection. FIG. 11 is a representation of an optical surface reflection pattern 1110 generated by a cross illumination array. The ‘cross shape’ is generated on the screen by the light source 150 used to illuminate the audience area. The cross pattern 1110 provides a different brightness vs. intensity graphical 1120 representation compared to a circular light source. The distribution is more even on the edges of the cross. Using patterns will reduce the number of false alarms from objects that reflect the infrared, for example jewellery, shiny objects.

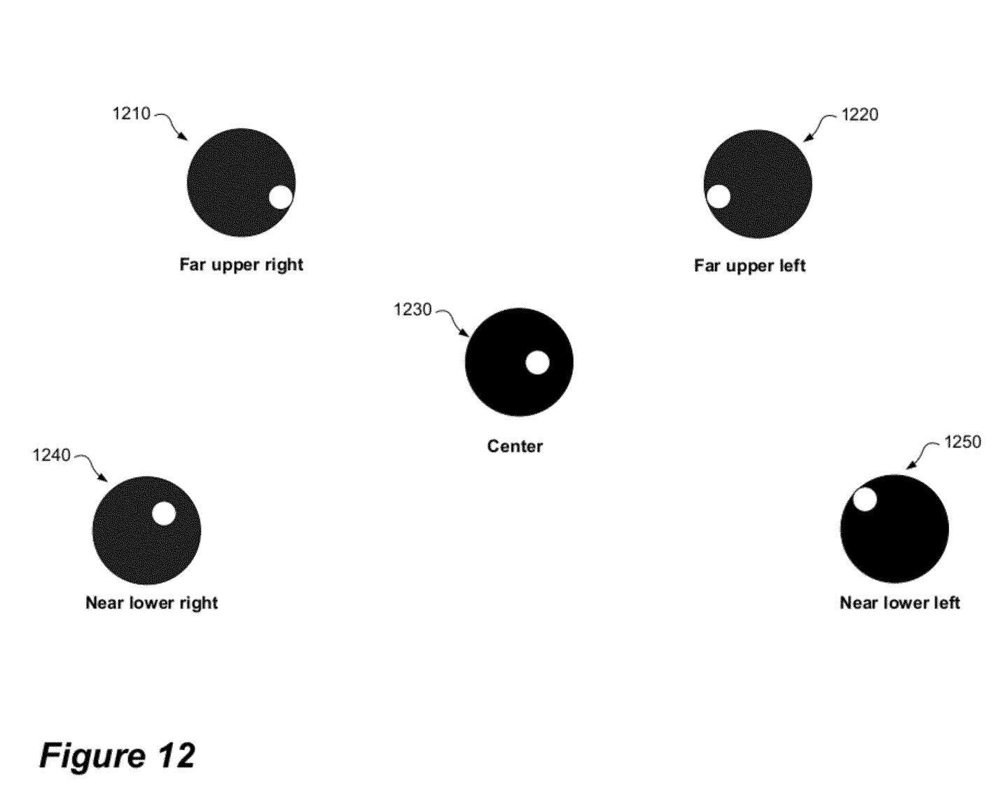

FIG. 12 is a representation of optical surface reflection pattern at different relative location in theater by a circular illumination array. Based upon the location of the illegal recording device 110 within the seating area, the pattern of the reflection will be different. For example, for a far upper right seating position, the reflection provided by a circular illumination array would provide a circular reflection pattern in the lower right portion of the lens 1210 of the device 110. A far upper left seating position would provide a circular reflection pattern in the lower left portion of the lens 1220. A center seating position would provide a circular reflection pattern in the center of the lens 1230. A near lower right seating position would provide a circular reflection pattern in the top right portion of the lens 1240. A near lower left seating position would provide a circular reflection pattern in the top right portion of the lens 1250. The pattern itself reduces the amount of false positive significantly since there is no other object in the scene that can generate same image.

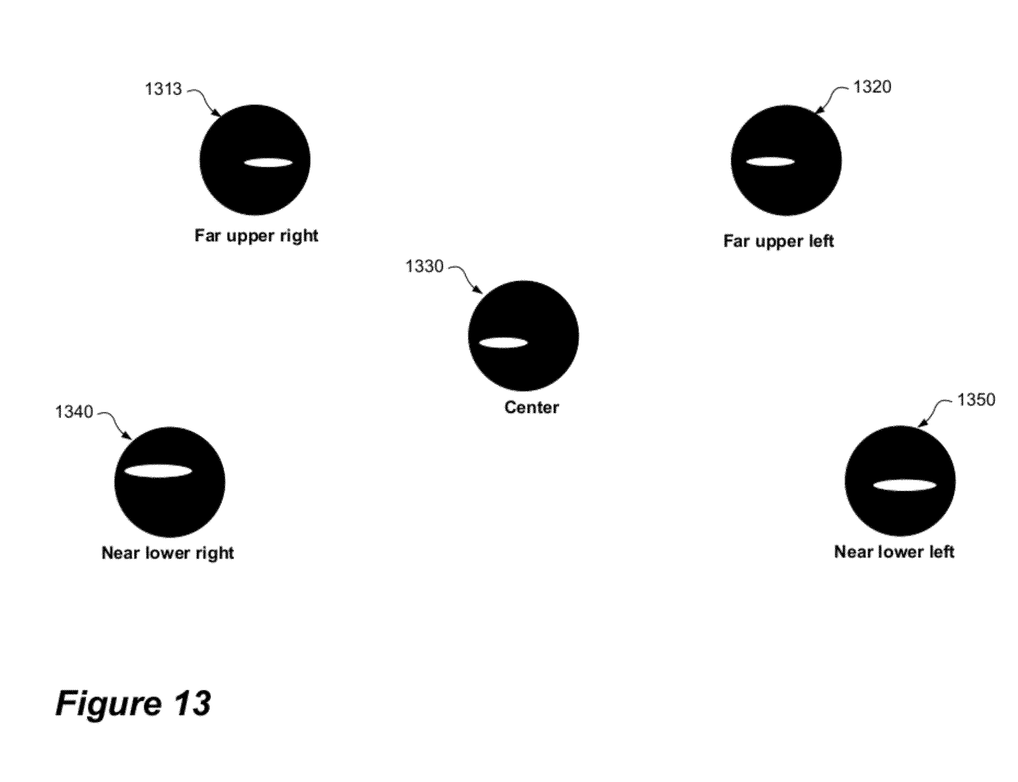

FIG. 13 is a representation of optical surface reflection pattern at different relative location by a linear illumination array. Based upon the location of the illegal recording device 110 within the seating area, the pattern of the reflection will be different. For example, for a far upper right seating position, the reflection provided by a linear illumination array would provide a more oval reflection pattern in the lower right portion of the lens 1310 of the device 110. Multiple reflections may be visible due to reflection from back from the lens of the video recording device. A far upper left seating position would provide a reflection pattern in the lower left portion of the lens 1320. A center seating position would provide a reflection pattern in the center of the lens 1330. A near lower right seating position would provide a reflection pattern in the top right portion of the lens 1340. A near lower left seating position would provide a reflection pattern in the top right portion of the lens 1350. The pattern itself reduces the amount of false positive significantly since there is no other object in the scene that can generate same image.

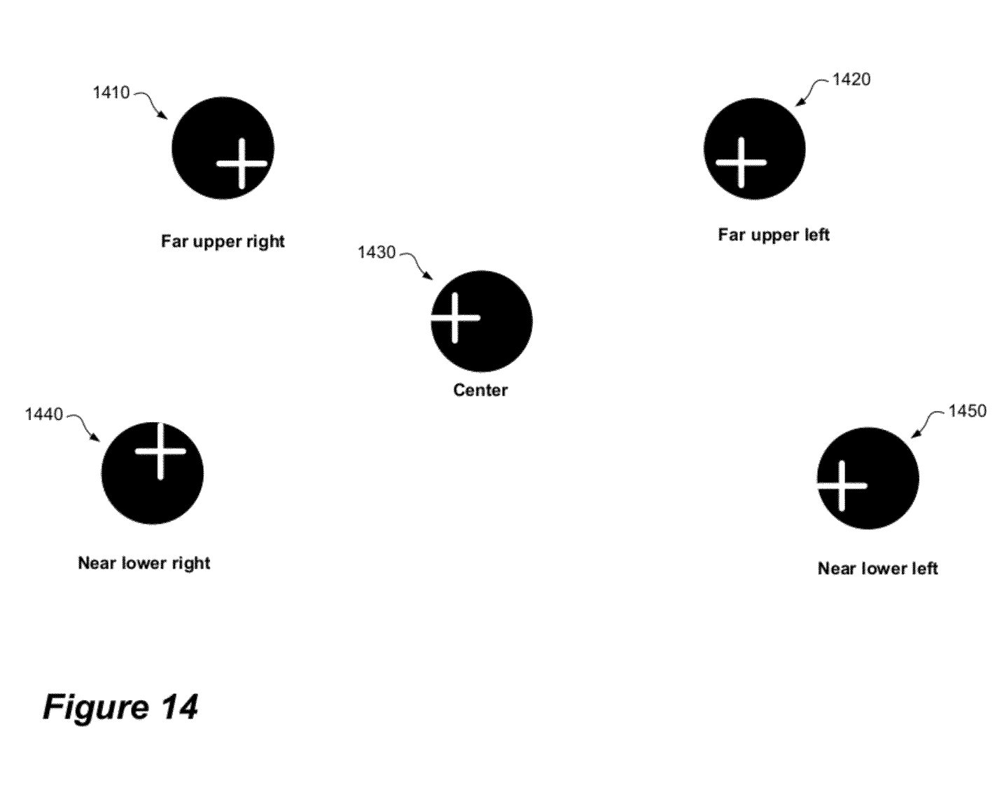

FIG. 14 is a representation of optical surface reflection pattern at different relative location by a cross illumination array. The lens of the illegal video recording device is detected by a pattern generated by an array formed like a “cross shape” by light source behind the screen. Based upon the location of the illegal recording device 110 within the seating area, the pattern of the reflection will be different. For example, for a far upper right seating position, the reflection provided by a cross-shape illumination array would provide a cross-shape reflection pattern in the lower right portion of the lens 1410 of the device 110. A far upper left seating position would provide a reflection pattern in the lower left portion of the lens 1420. A center seating position would provide a reflection pattern in the center of the lens 1430. A near lower right seating position would provide a reflection pattern in the top right portion of the lens 1440. A near lower left seating position would provide a reflection pattern in the top right portion of the lens 1450. The pattern itself reduces the amount of false positive significantly since there is no other object in the scene that can generate same image.

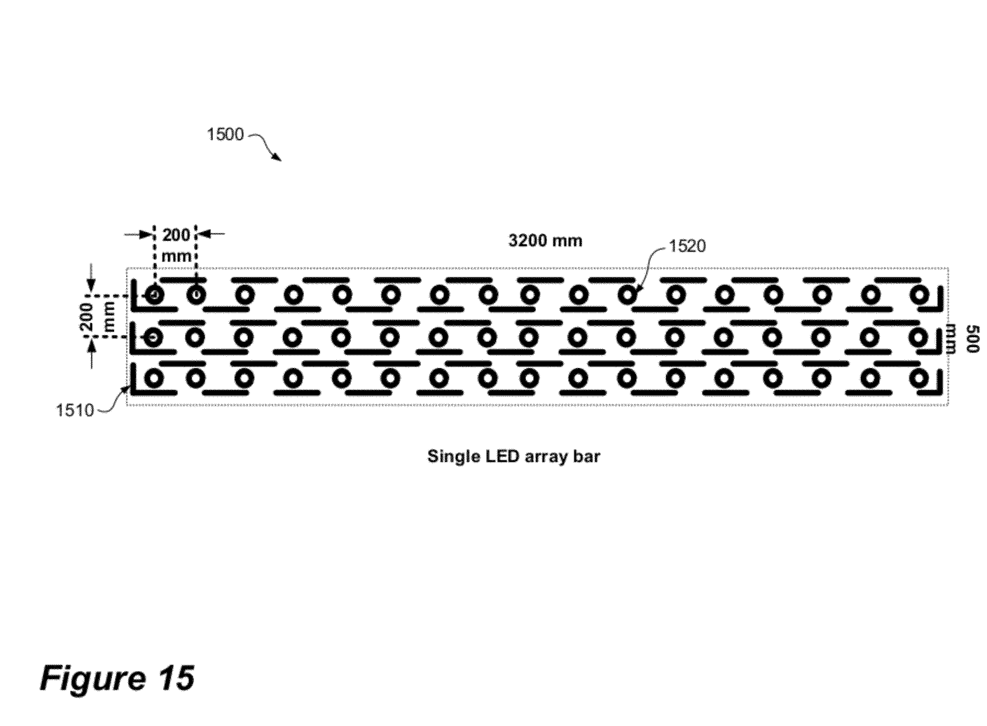

FIG. 15 is an illustration of an example infrared LED light array module configuration used for illuminating the audience seating area. The array architecture can be of any shape to generate a unique pattern reflect from the lens of the illegal recording device. Different patterns can be generated by different combination of array modules 1500. The array module 1500 utilizes individual light emitting diodes 1520

The LEDs have a pick illumination power at 950 nm and a lens designed to provide uniform illumination over the theater seats. Each array is comprised of 300 LEDs, place in multiple uniform rows 1510. LED array module is designed to generate a uniform pattern of light across the seats in the theater and provide an identifiable reflection patterns on the lens of the illegal video recording device. The array module 1500 can be composed of several rows of LEDs spaced equal to screen perforations where the focal point of the LED is in the middle of the hole in the screen. Although a rectangular configuration is shown, any number of configurations can be contemplated to provide audience illumination.

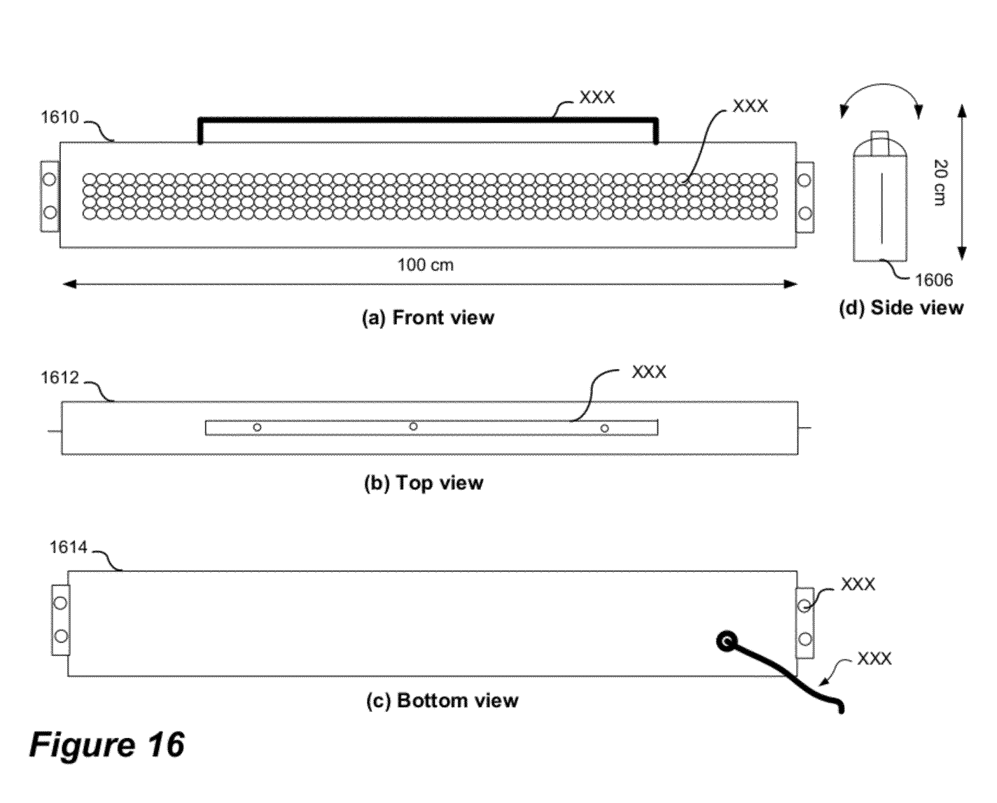

FIG. 16(a)-(d) are schematic illustrations of a LED light array apparatus. The LED array 1610 can comprise multiple LED light array modules 1510. As shown in FIG. 16(a) the front view of the array shows a plurality of LED lights arranged in rows. The array 1610 is approximately 100cm in length and 20cm in height. As shown in FIG. 16(b) and FIG. 16(d) a handle may be provided to facilitate installation and orientation of the array. Power is provided by a power cord 1640. Mounting plates 1650 with holes 1652 may be provided to mount the array. This illustration is for example only, as other configurations of the lighting array may be contemplated to achieve similar illumination results. Additional physical considerations can be added to enable rotation in the horizontal or vertical axis of the array. The sizes and dimensions in FIGS. 15 and 16 can be adjusted for each theater and screen type to transmit the maximum light from behind the screen and through the perforation. Each LED's focal point will placed in the middle of each hole in the perforation.

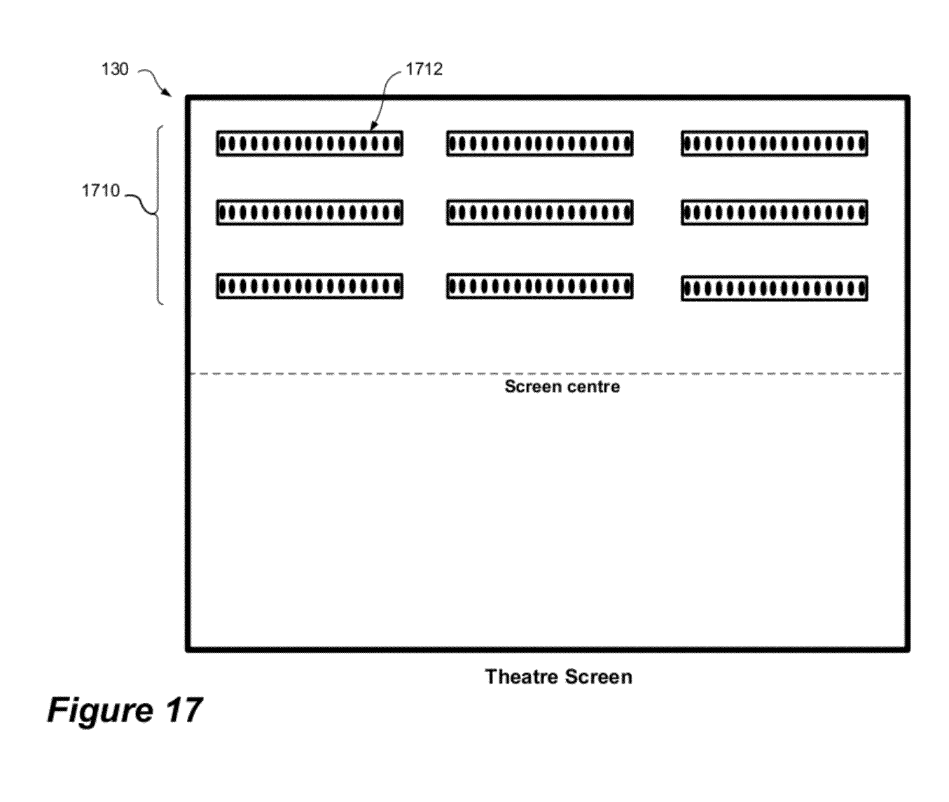

FIG. 17 is an illustration of a multiple infrared LED light arrays modules 1710 positioned behind the screen 130 for example in a movie theater environment. In this example the arrays are installed in several rows to cover the entire upper half of the screen above the screen center line. This generates the image of screen on the surface of flat and curved optical elements of camcorders in the theater. The arrays illuminate the audience through the screen. The number and layout of the light array will be dependent on illumination level required and the type of pattern to be generated on the audience.

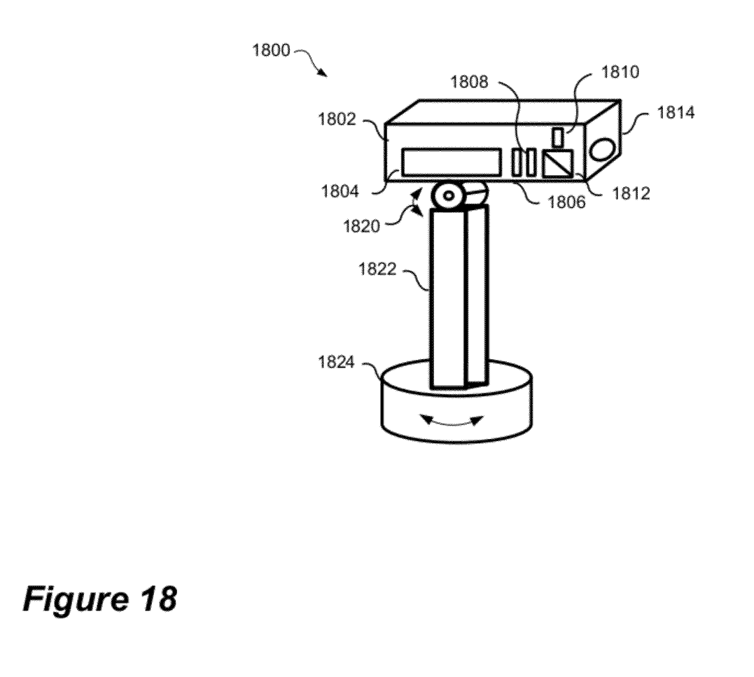

FIG. 18 is an example configuration of an image capture device 160 utilizing a pan-tilt camera 1800 with an integrated light source 1810. The light source may be an infrared LED source or infrared laser source. A moving platform 1824 is utilized allow the camera to scan the audience seating area. The image capture device can also be capable of a tilting 1820. Any part of the audience which is in the field of view of the CCD image generating sensor 1804 will be lit by the collimated light provided by illumination source 1810. In this example an infrared beam splitter prism 612 is provided to align the light source with the field of view of the CCD camera 334. When the collimated light from the illumination source 1810 hits the illegal video recording device 110, the light reflects back from its lens. The reflection is aimed at the retro reflector array which reflects the light back on the illegal video recording device lens and back to the light source. The collimated light now is large enough to be detected by the CCD image generating sensor 1804 after it passes through the visible light blocking filter 1806 and polarizing filter 1808. The CCD image generating sensor which is close to the light source will then detect the reflection. Alternatively the light source may be parallel to the imaging axis of the CCD image generating sensor 1804, therefore not requiring a beam splitter prism.

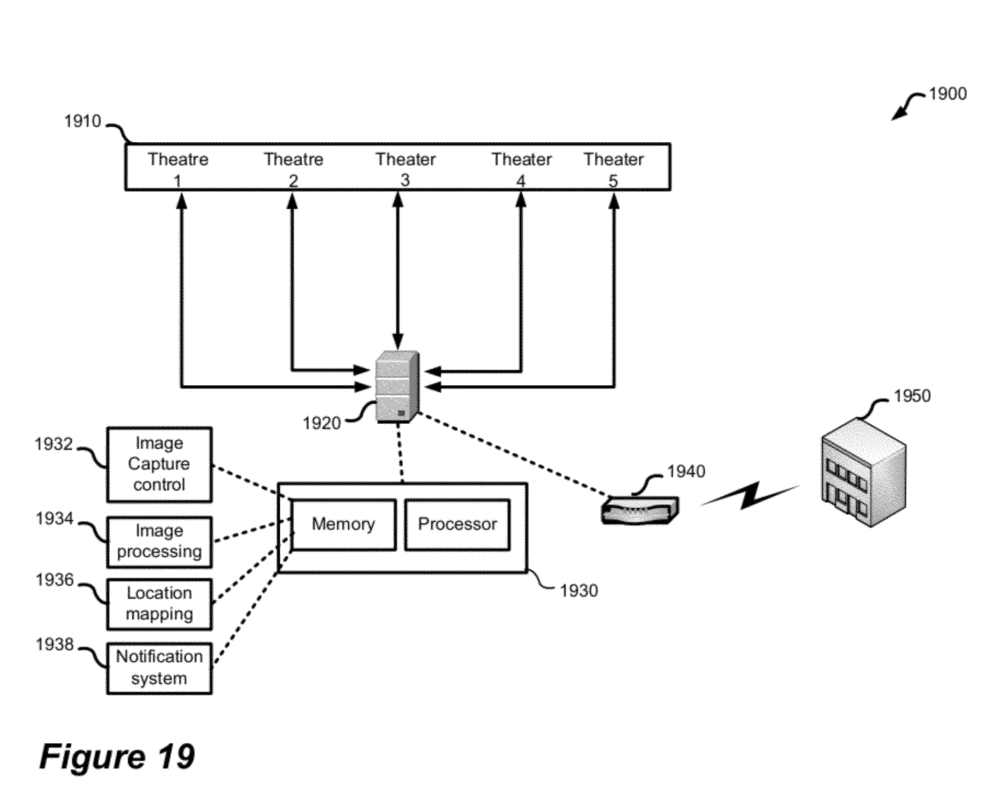

FIG. 19 is a system 1900 for detecting and alerting recording device in a theater environment. One or more theaters 1910 are connected to a central server 1920. Each theater contains a detection system comprising illumination devices and an image capture device to capture images of the audience area. The detection systems 1910 are networked to a central server 1920 for either receiving images from each detection system for image processing to detect patterns or for receiving notification of alarms from processor dedicated to or resident in each theater. The central processing system 1920 is connected to the central monitoring system 1950 through a wired or wireless network interface 1940. The alarm is processed by central monitoring system 1950 where the authorities are informed of the video piracy act in the theater. Alternatively the alarms may be provided locally so that immediate action may be taken. The central server 1930 comprises at least a processor 1932 for executing instruction provided by a memory 1934. The memory contains instructions for providing one or more functions utilized detecting illegal video recording devices. The functions may be divided by image capture control 1942 for operating the image capture device in an individual theater or device in each theater, image processing 1944 for processing received images to determine reflection patterns, location mapping 1946 for determining a location of a reflected pattern by correlating the image to seating position in the theater. Notification system 1948 can then provide an appropriate alert to a central monitoring system 1950 through an networking interface 1940 through a specified messaging protocol.

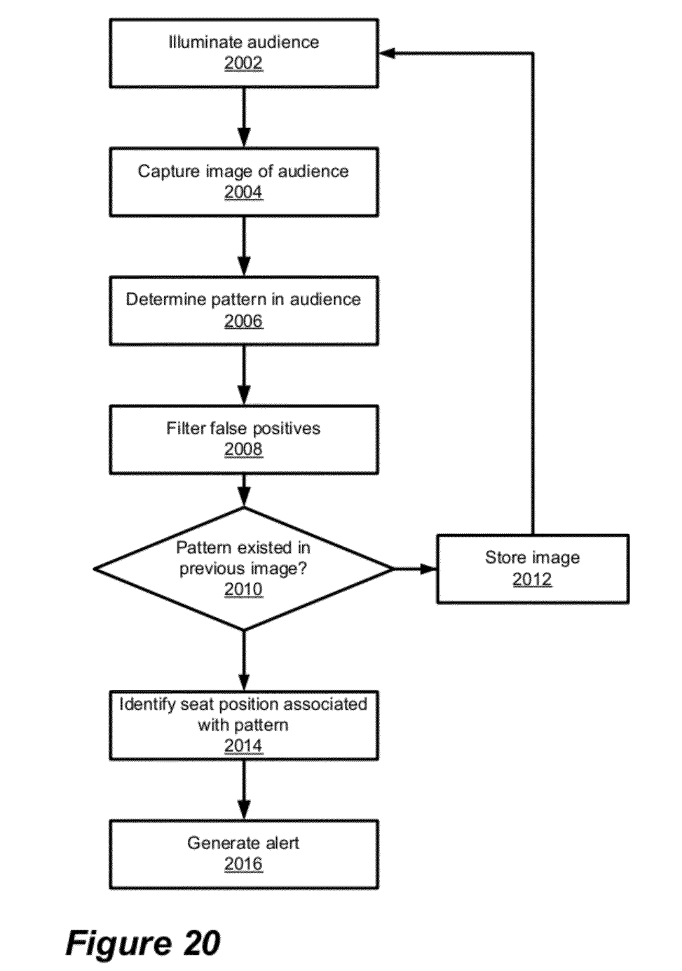

FIG. 20 is a flow chart of recording device detection. The audience seating area is illuminated by one or more infrared sources (2002). Reflections from the seating area is captured by an image capture device (2004). Images of the seating area may be done in sections by for example using a pan-and-tilt camera. Alternatively images may be received from multiple cameras covering the seating area or by a single camera capable of capture a significant portion of the seating area in a single image. Reflection patterns are then detected, based upon the illumination configuration, by analyzing the received images (2006) by performing pattern matching and determining a sudden rise in the intensity of a reflection in the infrared image. Images that do not contain any patterns are remove (2008) or possibly stored but are not considered in the current process. If a reflection pattern is identified in the image, a previous image of the same location is retrieved (2010) to perform a pixel to pixel comparison and determine if the object associated with the pattern has not moved and reflection patterns are still there within a defined tolerance. This may be performed across a defined period of time or multiple frames to ensure a positive identification of a recording device. If the pattern was in previous images, and therefore a high likelihood of a recording device (YES at 2010) the seat position associated with the pattern is identified (2014) by mapping the captured imaged to a defined seating pattern and a seating position. (I ASSUMED The theater is calibrated before operation and the position of each seat is associated with the coordinate of the scanning camera and scanning laser light (if a laser scanner is used)). An alert can then be generated (2016) providing an image or a series of images of the illegal video recording device in the scene and an image of people surrounding the detected pattern. If the pattern does not exist in a previous image (NO at 2010), the image is stored 2012 for later comparison. The storage of the image may include an index to either a position of camera when the image was captured or reference to a specific location of audience that image was taken, in which case (2014) would occur prior to (2012). The alert may also include an image of one or more faces in the immediate area of the detect video recording device.

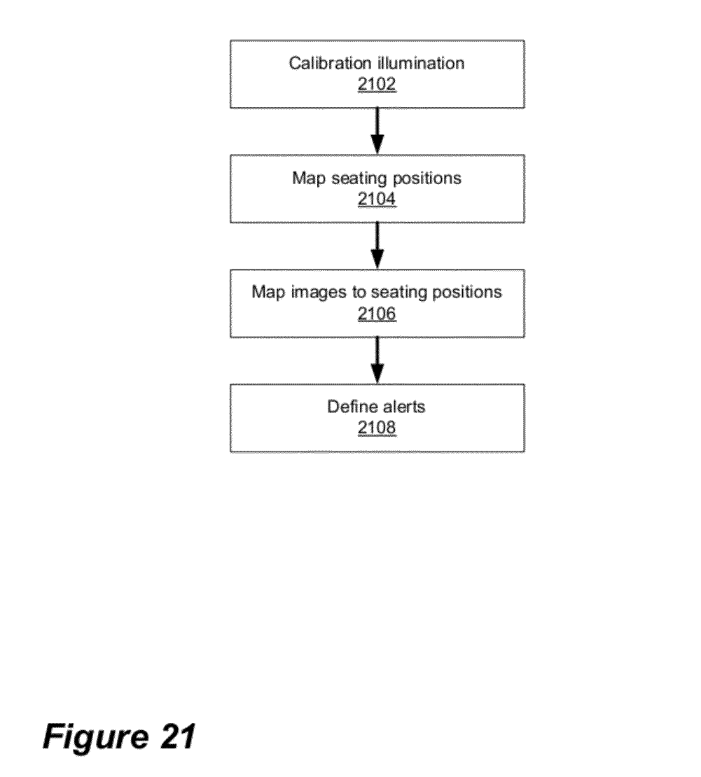

FIG. 21 is a flow chart of detection system installation. After the illumination arrays are installed in the theater they are calibrated (2012) to ensure even illumination through out the desired seating area. Seating positions can then be mapped (2104) to camera positions to provide a mapping of the generated images and one or more camera positions. The illumination pattern generated by illumination array can then be identified or adjusted (2016) to be utilized in the pattern detection. The types of alerts that are to be generated and tolerances for generating the alerts can then be identified.

The system, apparatus and methods according to the present disclosure may be implemented by any hardware, software or a combination of hardware and software having the above described functions. The software code, either in its entirety or a part thereof, may be stored in a computer-readable memory. Further, a computer data program representing the software code may be embodied on a computer-readable memory.

While a particular embodiment of the present device and methods for providing video recording device detection, it will be appreciated by those skilled in the art that changes and modifications may be made thereto without departing from the disclosure in its broadest aspects and as set forth in the following claims.

1. A system for detecting a video recording device, the system comprising:
a continuous infrared illumination source for illuminating an audience seating area;
an image capture device facing the audience seating area, the image capture device for capturing infrared images of the seating area; and
an imaging processor coupled to the image capture device, the imaging processor receiving an image of the seating area and identifying infrared optical surface reflections within the received image, the reflections identified by a infrared reflection pattern produced by the surface of a lens of the video recording device.

2. The system of claim 1 wherein the pattern is further determined based upon a light intensity image profile change.

3. The system of claim 2 wherein the reflection pattern is defined by: one or more circular bright spots from the lens of the video recording device defining an associated intensity image profile; one or more horizontal bright ovals from the lens of the video recording device defining an associated intensity image profile; or one or more horizontal bright cross-shapes from the lens of the video recording device defining an associated intensity image profile.

4. The system of claim 2 wherein the imaging processor performs a pixel to pixel comparison of a currently captured image to one or more previously captured images to determine if an identified pattern has not moved, to eliminate reflective objects from identification.

5. The system of claim 4 wherein a continuous infrared illumination source is a laser scanner.

6. The system of claim 4 wherein the continuous infrared illumination source is an infrared light emitting diode array module.

7. The system of claim 5 wherein the illumination source is collocated with the image capture device and is coupled to an imaging axis of the image capture device by a infrared beam splitter prism.

8. The system of claim 6 wherein the continuous infrared illumination source comprises two or more rows of light emitting diodes.

9. The system of claim 1 wherein the image capture device is scanning imaging camera, movable for scanning across the seating area.

10. The system of claim 9 wherein the image capture device is movable in the horizontal and vertical axis's, the image capture device scanning the seating area in a defined scan pattern, the theater seat locations is associated to scanning coordinates of the camera to specify the location of each seat during the scanning.

11. The system of claim 10 wherein the imaging processor maps a position of the camera to the received image to determine a seating position identified within the frame.

12. The system of claim 6 wherein the illumination source is behind a screen facing the audience.

13. The system of claim 6 wherein the illumination source is coupled to image capture device providing illumination along a same imaging axis as the image capture device.

14. The system of claim 6 wherein the illumination source is in front of screen, the system further comprising a retro reflector located behind screen to reflect IR light from the illumination source to the audience.

15. The system of claim 6 wherein the illumination source is to the side of screen, the system further comprising a retro reflector located behind screen to reflect IR light from the illumination source towards the audience.

16. The system of claim 4 wherein the image processor identifies one or more patterns in the theater, the image processor further comprising a network adapter for providing an electronic notification to one or more destinations that one or more patterns have been detected and identifying a seating position associated with the pattern.

17. The system of claim 4 further comprising capturing a picture image of a face associated with the seating position.

18. The system of claim 4 wherein the image capture device further comprises charged coupled device (CCD) detection sensor.

19. The system of claim 18 wherein the image capture device further comprises a narrow band pass blocking filter which blocks the visible light and transmits the infrared light- placed in front of the CCD sensor.

20. The system of claim 19 wherein the image capture device further comprises a polarizer lens located in front of blocking filter on the CCD sensor.

21. A method of detecting a recording device in a theater, the method comprising:
generating a continuous infrared illumination of an audience seating area in the theater;
capturing an infrared image of the audience seating area;
processing the image to determining if one or more infrared patterns generated by a retro-reflection from a lens surface of the recording device.

22. The method of claim 21 wherein processing the image further comprising determining a light intensity image profile change to identify the pattern.

23. The method of claim 22 further comprising comparing the image to a previously captured image to determine if the one or more infrared patterns where present.

24. The method of claim 23 wherein comparing the image to a previously captured image comprises a pixel by pixel comparison to identify the pattern.

25. The method of claim 24 further comprising generating an alarm when a pattern is identified in the image.

26. The method of claim 25 further comprising identifying a seating position associated with the reflection pattern in the image.

27. The method of claim 26 wherein identifying a seating position further comprises providing an image containing a face of a person associated with the seating position.

28. The method of claim 27 wherein the reflection pattern is defined by: one or more circular bright spots from the lens of the video recording device defining an associated intensity image profile; one or more horizontal bright ovals from the lens of the video recording device defining an associated intensity image profile; or one or more horizontal bright cross-shapes from the lens of the video recording device defining an associated intensity image profile.

29. The method of claim 21 wherein a continuous infrared illumination source is a laser scanner.

30. The method of claim 21 wherein the continuous infrared illumination source is an infrared light emitting diode array module.

31. The method of claim 30 wherein the continuous infrared illumination source comprises two or more rows of light emitting diodes.

32. The method of claim 31 wherein the illumination source is behind a screen facing the audience.

33. The method of claim 26 wherein capturing the infrared image comprises scanning across the seating area in a defined scanning sequence.

34. The method of claim 33 wherein the illumination source is coupled to image capture device providing illumination along a same imaging axis as the image capture device.

35. The method of claim 31 wherein the illumination source is in front of screen, the method further comprising a retro reflector located behind screen to reflect IR light from the illumination source to the audience.

36. The method of claim 31 wherein the illumination source is to the side of screen, the method further comprising a retro reflector located behind screen to reflect IR light from the illumination source towards the audience.

37. The method of claim 31 wherein the image capture device further comprises charged coupled device (CCD) detection sensor, a narrow blocking filter which blocks the visible light and transmits the infrared light- placed in front of the CCD sensor and a polarizer lens located in front of blocking filter on the CCD sensor.
